(19) United States
(12) Patent Application Publication
(10) Pub. No.: US 2021/0191610 A1
(43) Pub. Date: Jun. 24, 2021

(54) Head-Up Display Controller

(71) Applicant: Barton Jenson, Everett, WA (US)

(72) Inventor: Barton Jenson, Everett, WA (US)

(21) Appl. No.: 16/696,435

(22) Filed: Nov. 26, 2019

Related U.S. Application Data
(63) Continuation-in-part of application No. 14/326,376, filed on Jul. 8, 2014, now abandoned.

(51) Int. Cl. G06F 3/0488; G06F 3/0482; G02B 27/01; B60K 35/00

(52) U.S. Cl. CPC G06F 3/04883; G06F 3/0482; G02B 27/0101; B60K 2370/166; G02B 2027/0141; B60K 2370/146; B60K 2370/1529; B60K 35/00

(57) ABSTRACT

Disclosed, among other things, are techniques to allow information from multiple devices to be displayed on a Head-Up Display, allowing a user to focus on safety while being distracted minimally, but still benefiting from having the multiple devices. Head-Up Display Controller may also display only important information, and use simple-to-understand symbology, which may allow a user to quickly and easily see and understand information on the Head-Up Display.

### RELATED APPLICATIONS

This application claims priority to and is a continuation in part of U.S. patent application Ser. No. 14/326,376, entitled “Head-up Display Controller,” filed on Jul. 8, 2014, the contents of which are incorporated by reference herein in their entirety.

### FIELD

This disclosure relates to a Head-Up Display Controller.

### BACKGROUND

More and more electronic devices are finding their way into use while their users are driving or operating equipment. Mobile phones, GPSs, business communication radios, entertainment systems, vehicle monitoring systems, portable computers, and other electronics draw a driver's attention from what's ahead or around them to each of the displays involved.

These distractions are responsible for many accidents for cars, trucks, and heavy equipment, or can substantially reduce the efficiency of operating a vehicle.

### SUMMARY

The instant application discloses, among other things, techniques to allow information from multiple devices to be displayed on a Head-Up Display (HUD), allowing a user to focus on safety, or important tasks, while being minimally distracted, but still benefiting from having the multiple devices. While using a Head-Up Display may help reduce distractions by prioritizing information displayed to a user to reduce a cognitive load presented during operation of a vehicle, Head-Up Display Controller may also display use simple-to-understand symbology, which may allow the user to quickly and easily see and understand information on the Head-Up Display.

A head-up display may be a display configured to present visual information along the line of sight of a user. For example, a head-up display used in a car may allow a driver to continue looking through a windshield while seeing visual information displayed in the driver's field of vision.

### BRIEF DESCRIPTION OF THE DRAWINGS

FIG. 1 is a system diagram of an embodiment of Head-Up Display Controller.

FIG. 2 illustrates data flows between a Device 2-1, such as a smart phone, laptop, or tablet computer and Head-Up Display Controller.

FIG. 3 is an example of a touch-based menu, according to one embodiment.

FIGS. 4-7 illustrate a menu navigation flow chart example.

FIG. 8 illustrates a Head-Up Display Controller according to one embodiment.

FIG. 9 illustrates a flow chart for Head-Up Display Controller, according to one embodiment.

FIG. 10 illustrates a flow chart for selection of various sources of information and display on HUD, according to one embodiment.

FIG. 11 illustrates a flow chart for selection of various sources of information and display on HUD for a first responder, according to one embodiment.

FIG. 12 is a system diagram of one embodiment of a Head-Up

Display Controller.

FIG. 13 illustrates a component diagram of a computing device according to one embodiment.

### DETAILED DESCRIPTION

Head-Up Display Controller may intelligently combine data and control functions from multiple devices into a single head-up display with simplified symbology, allowing a user to focus on other tasks, while still benefiting from the functionality of the multiple devices. Control of the multiple devices may be accomplished using blind user interface techniques, for example voice recognition, gestures, or simple touch commands.

In one example implementation, the Head-Up Display Controller limits the amount of information displayed to a user on the Head-Up Display at one time. Limiting the amount of information displayed may prevent a user from becoming overwhelmed with data, thereby eliminating extraneous information that can unnecessarily tax a driver.

A more particular description of certain embodiments of Head-Up Display Controller may be had by references to the embodiments shown in the drawings that form a part of this specification, in which like numerals represent like objects.

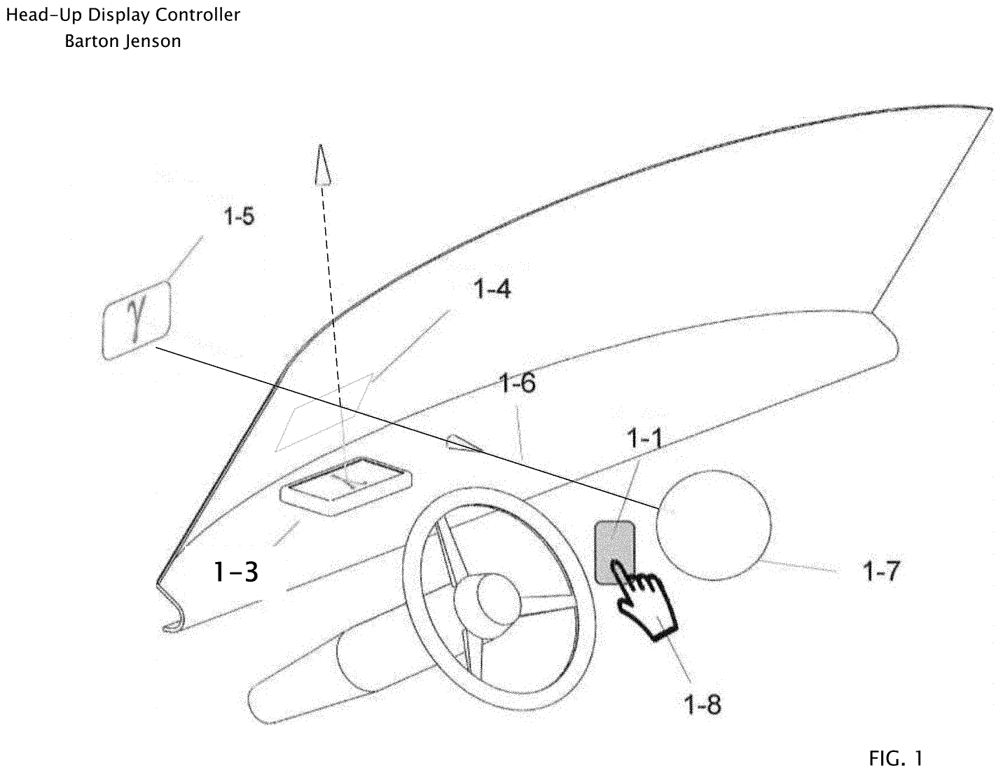

FIG. 1 illustrates a use of a Head-Up Display Controller, according to one embodiment. In this embodiment, a head-up display (HUD) may be configured to operate in tandem with a mobile device, such as a smartphone or laptop computer, with output from the mobile device displayed on the HUD.

In this example, a smart phone (1-1) may be connected via cable or wirelessly, to a HUD projection unit (1-3), which may project display imagery onto an optical combiner (1-4) within an automobile. The optical combiner may be positioned to superimpose display imagery (1-5) onto the vehicle operator's line-of-sight (1-6). The vehicle operator's head (1-7) may be positioned in a normal manner to allow a view of the road through the combiner while operating the vehicle. The vehicle operator may use simple touch commands to navigate through menu options or control display content, using digits on the hand (1-8), without removing their eyes from the display or road. This may be considered a blind-touch user interface. A blind-touch (or blind user interface) may be an interface that does not rely on sight to control or receive information from a piece of equipment or device. For example, voice input, gestures, touch inputs, finger movements, or head movements may be forms of blind user interfaces. The touchpad on a laptop or touch-screen on a tablet computer may be used if the laptop or tablet computer are utilized and configured to control HUD content.

The application of this system may extend to any vehicle platform beyond the automobile, including but not limited to haul trucks, dump trucks, tractors, combines, cranes, trains, airplanes, boats, and spacecraft. In any of these vehicle platforms, data from gages, instruments, warning systems, a dispatch center or other sources may be important to display on a HUD without causing the vehicle operator to divert their eyes from an important task. The performance of the task may be enhanced by allowing the vehicle operator to keep their eyes on a critical part of the task. The controlling of other devices and accessing of information important in the performance of that task may improve efficiency if the vehicle operator sees that information overlaid on a natural scene.

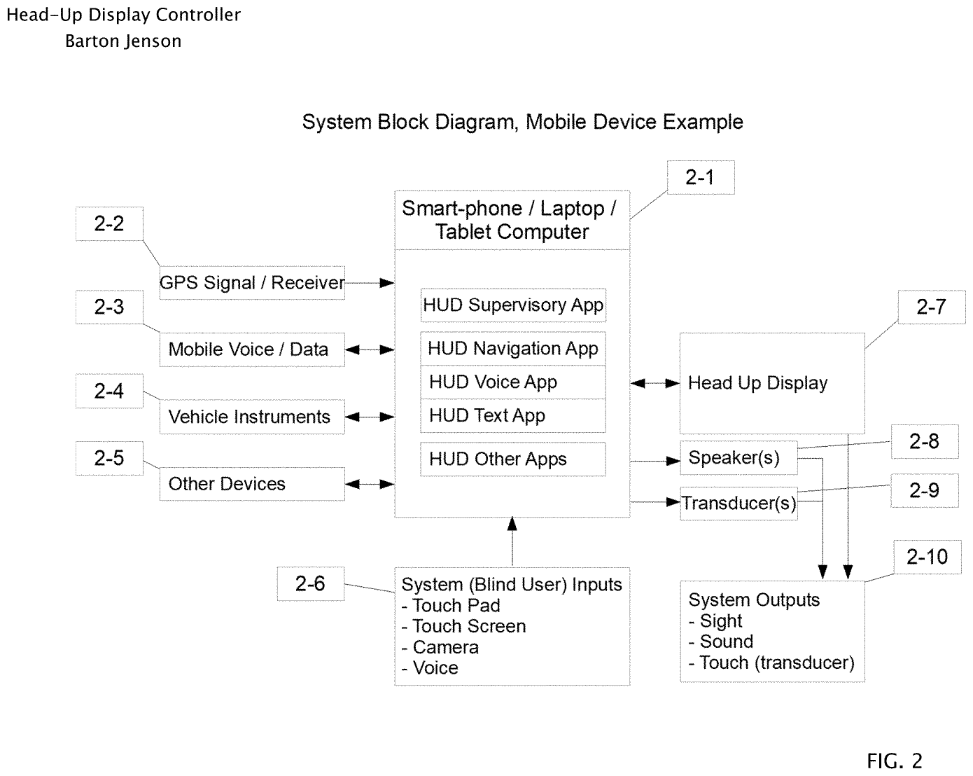

FIG. 2 illustrates data flows between a Device 2-1, such as a smart phone, laptop, or tablet computer and Head-Up Display Controller. Device 2-1 may include sources of information such as a GPS receiver (2-2), mobile voice/data service (2-3), vehicle instruments (2-4), or other devices (2-5). Connection to these other devices or sources of information may be hard-wired or through wireless connections such as Blue Tooth, or WiFi (IEEE 802.11), or other means of communication. The system may have the ability to receive blind user inputs (2-6); that is, user inputs that allow efficient access without direct visual contact. This may be done a variety of ways using components on the mobile device such as the device's touch-screen, camera or microphone. System outputs may consist of a HUD image (2-7), speaker sound output (2-8), transducer outputs (2-9) that may vibrate or other system outputs (2-10) that generally do not require operator sight. Transducers may be located in a driver's seat or on specific control devices within the vehicle in order to alert the driver about certain conditions or information by vibrations, taps, or patterns of vibrations and taps.

Dedicated user interface devices may be connected to the mobile device, either hard-wired or wirelessly. For example, a dedicated touchpad that is located in a convenient location for a vehicle operator to access may enable greater efficiency of the vehicle operator interacting with multiple devices simultaneously. A dedicated touchpad may also be designed to integrate with a steering wheel, vehicle control, dashboard, or other part of a vehicle, which may not be easily done with a larger mobile device such as a laptop. This may allow the vehicle operator to keep their hands on or near the primary vehicle controls.

The system may receive blind user inputs through the user interface, which may be simple touch-based inputs, as shown in Table 1 below. The user interface and HUD system may be specifically designed to not require the vehicle or equipment operator to look at the user interface, unlike a keypad on a cell phone. The blind user inputs may also be specifically designed not to require much manual dexterity. For example, a touchpad used in conjunction with a display that shows a cursor location, whereby an operator must move the cursor to specific locations, such as icons or keypad digits, requires a higher level of manual dexterity and coordination than swipes and symbols that ignore position and register motion. Swipe motions do not require precise taps, and are more desirable for a HUD system utilizing the blind interface described herein.

For example, a cell phone keypad that is strictly touch-based may require the user to look and see where each number is that they desire to press. A blind touch-screen user interface may merely require that the user feel where the touch screen is and make simple strokes, symbols, or combinations thereof. A very rich command set can be developed this way. The touch screen may be programmed to be blank during use, in which case the user may have no reason to look at the touch screen and is encouraged to look at the HUD image, which may be disposed in a desirable viewing position.

TABLE 1
Example User Interface Command Set

| Touch Input | HUD Action | HUD Output |
|---|---|---|
| Upward stroke | Scroll up (alternate | Next item in list is |
| | down) through list of | highlighted or centered |
| | menu options or items | in display |
| Downward stroke | Scroll down (alternate | Previous item in list is |
| | up) through list of menu | highlighted or centered |
| | options or items | in display |
| Right stroke | Menu item select; enter | Sub-menu is displayed |
| | sub-menu for item | |
| | currently selected | |
| Left stroke | Menu item de-select; | Sub-menu is removed |
| | exit sub-menu for item | from display and higher- |
| | currently selected | level menu is displayed |
| Clockwise stroke | Scroll forward or down | Next item in list is |
| | through list of menu | highlighted or centered |
| | options or items | in display |
| Counter-clockwise | Scroll backwards or up | Previous item in list is |
| stroke | through list of menu | highlighted or centered |
| | options or items | in display |
| Single tap | Menu item select; enter | Sub-menu is displayed, |
| | sub-menu for item | or appropriate display |
| | currently selected. Or, | symbology for action. |
| | execute action if item | |
| | does not have sub- | |
| | menu. Or, wake device | |
| | and bring up menu for | |
| | current application | |
| Double tap | Execute action. Or, if | Appropriate display |
| | sub-menu applies, then | symbology for action |
| | execute default action | |
| | for menu item selected | |
| Special stroke/ | Short cut to specific | Appropriate display |
| set of strokes | menu item or action | symbology for menu |
| in succession | | item or action. |
| Two fingers | Zoom in | Zoom in on selected |
| spreading apart | | area on display |
| Two fingers | Zoom out | Zoom out on display |
| moving closer | | |
| together | | |

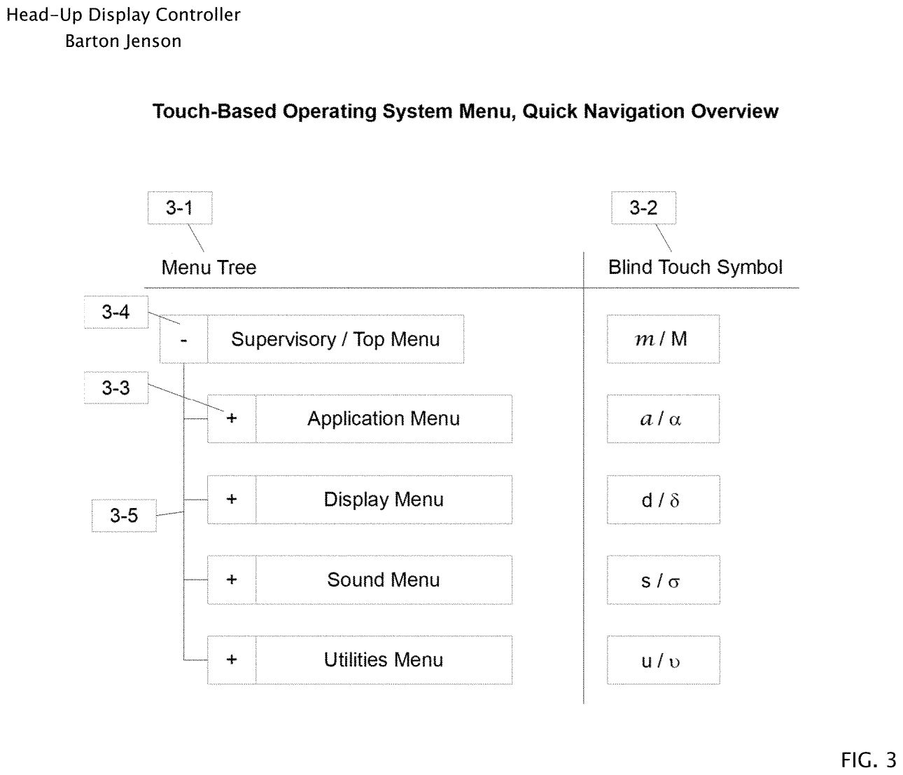

FIG. 3 is an example of a touch-based menu for quick navigation, according to one embodiment. Quick navigation through menu options may be possible with special strokes, as shown in FIG. 3. Various menu options are shown in the left-hand column (3-1) in a hierarchical schema as depicted with the “+” sign and “−” signs. For example, the“+” sign (3-3) on the application menu may denote additional menu options or functions are available. The “−” sign (3-4) may denote that all sub-menu options or functions subsidiary to the application menu are shown by the line connecting the box with the minus sign (3-5) to other boxes containing “+” signs. Navigating in and out of different menu options or software applications, may be possible with blind touch symbols (3-2), or simple and special strokes as shown in the right-hand column. These blind touch symbols may enable shortcuts to specific menu options or applications. These special strokes may be simple symbols or letters that do not require the operator to look at the touch screen. In this way, the system may provide a blind user interface with quick navigation.

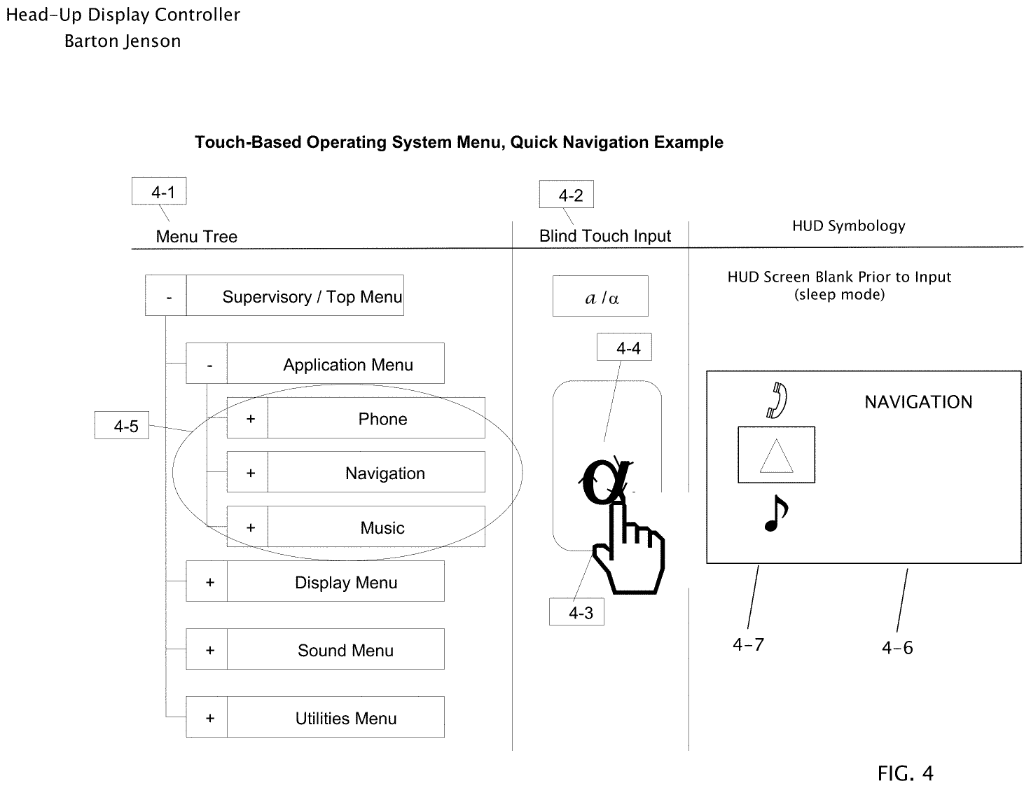

FIGS. 4-7 illustrate a menu navigation flow chart example. A sequence of user inputs is shown from FIG. 4 to FIG. 7. A hierarchical menu tree is shown in the left-hand column of the flow chart (4-1). Blind touch input is shown in the middle column (4-2). A smart-phone is shown (4-3) as the input device, however a touchpad on a laptop, a touch screen on a tablet computer, or a dedicated touchpad are other examples of potential input devices. The example menu navigation may begin with the system in a neutral, or sleep state in which there is no display output. The system may also be in any other state of operation with the HUD image displaying content appropriate to that state.

The user may input a Greek letter alpha (4-4) on the touch interface, which may immediately take the system to the applications menu (4-5). In this example, Navigation is the default application, which is shown on the HUD image (4-6). The HUD image may show all applications available to the user (4-7).

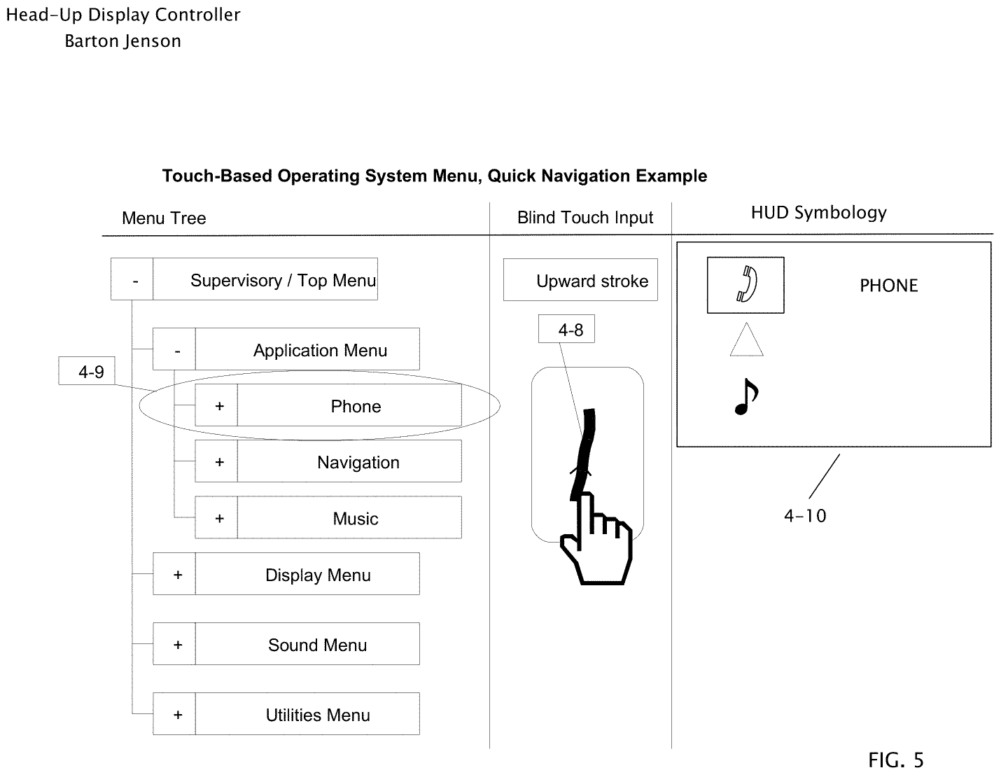

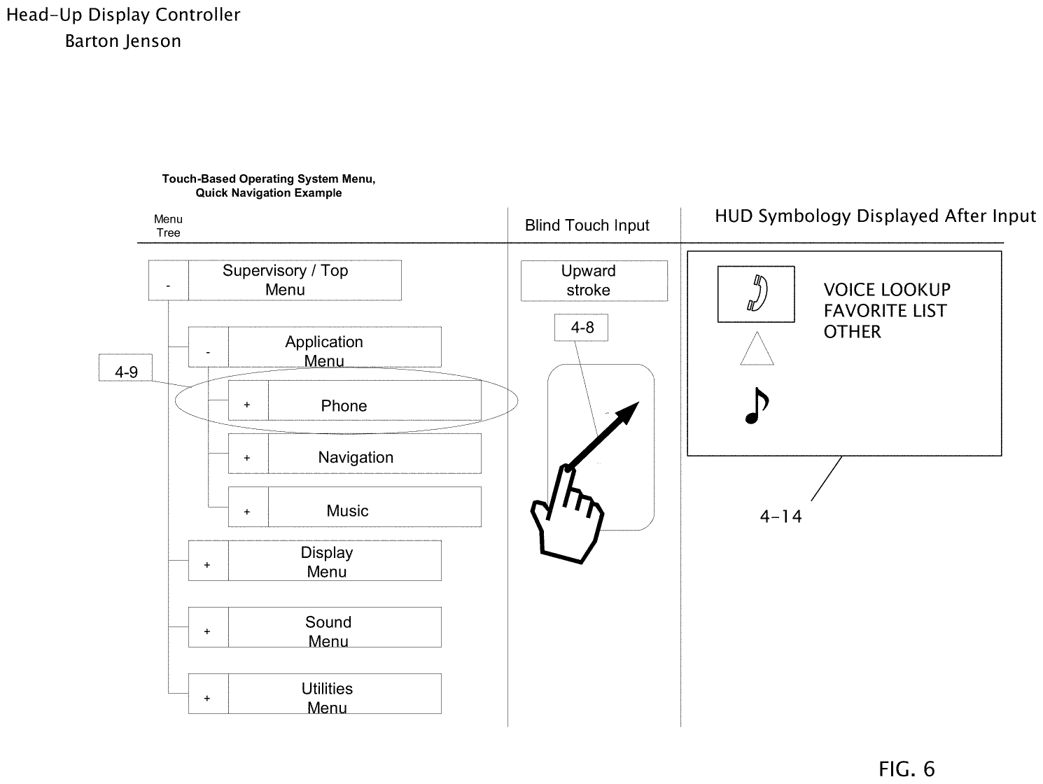

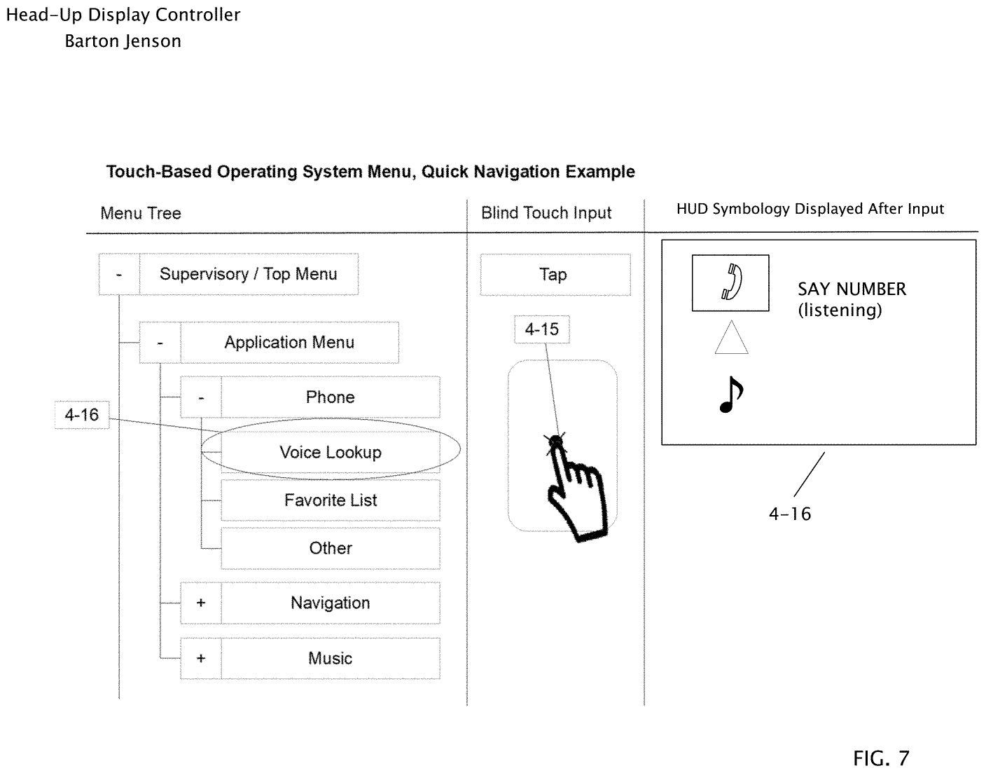

On FIG. 5, an upward stroke (4-8) may take the system to the phone application (4-9), which may be displayed in the HUD image (4-10). FIG. 6 then shows that a right stroke (4-12) may take the system to the phone application menu (4-1 3), which may be displayed in the HUD image (4-14). FIG. 7 shows that from there, a tap (4-15) on the voice input menu option within the phone application (4-16) may execute a command for the system to receive voice phone number input, as shown in the HUD image (4-1 7). None of the user touch inputs may require the operator to look at the touch screen. None of the user touch inputs may require the operator to look at the touch screen, nor require a high level of manual dexterity for touch gesture input.

Feedback that the user is navigating through the menu options may be in the HUD display output, which may encourage or require the vehicle or equipment operator to keep their eyes pointed in a desirable direction.

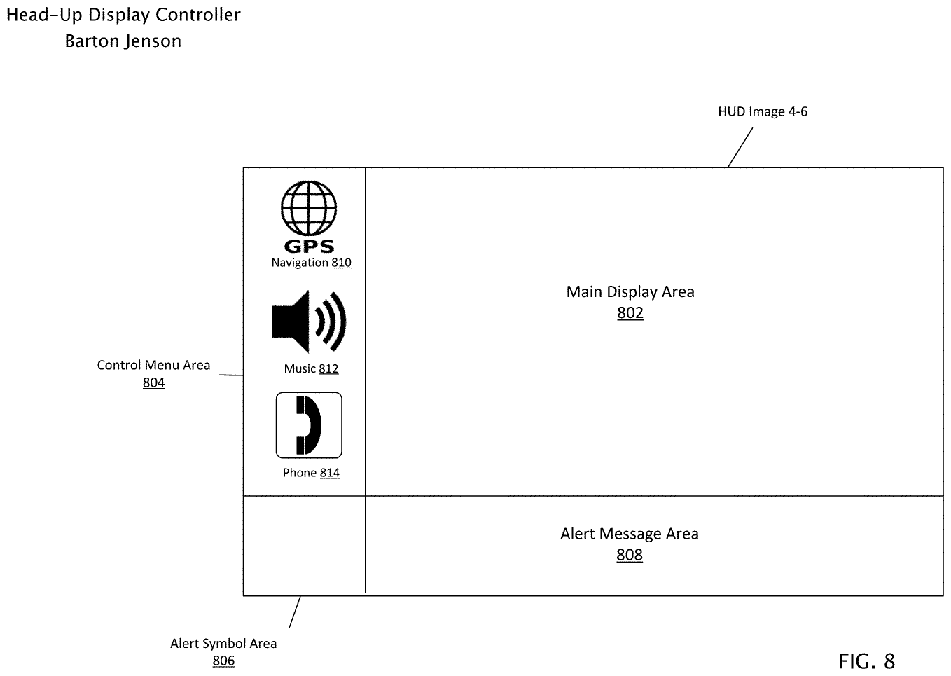

FIG. 8 illustrates a Head-Up Display Controller according to one embodiment. As illustrated in FIG. 8, a HUD Image 4-6 may include, without limitation, a main display area 802, a control menu area 804, an alert symbol area 806, and an alert message area 808. Control menu area 804 may display one or more sources of information associated with one or more applications. A vehicle operator may navigate and select which applications they would like to have displayed in control menu area 804, using one or more gestures similar to those described in Table 1. Utilizing the gestures described in Table 1 permits the vehicle operator to scroll through a list of application options while keeping their eyes on the road.

Each application may be represented by an icon, as illustrated in control area 804. The icon may be, for example, presented in a large symbolic form such that the user can easily identify the icon and the application associated therewith. By way of example only, navigation application 810 may be represented by a globe and the letters GPS, music application 812 may be represented by a speaker, and phone application 814 may be represented by a telephone receiver. While only three applications are shown, it is to be appreciated that more than three applications may be displayed at one time in control menu area 804. However, presenting too many options to a vehicle operator may be distracting to a user as they attempt to navigate the Head-Up Display Controller and still safely operate a vehicle. Moreover, where control area 804 may only display three applications, as a user scrolls through an application list utilizing the gestures described in Table 1, an icon may move off of control menu area 804, and a new icon representing another application may appear. By presenting the user the option to scroll through application options yet only present three applications at any one time, the user is not overwhelmed with information and subsequently potentially distracted while operating the vehicle.

Prioritizing what information to display to a vehicle operator is an important consideration. In one example, the purpose of prioritizing information presented to the vehicle operator may be to reduce a cognitive load, thereby eliminating extraneous information that can unnecessarily tax the vehicle operator.

Priority determinations may be set by default or may be configured by users. They may be based upon safety or human factor conditions, or upon convenience considerations. For example, an incoming call may cause caller ID information to replace engine RPMs on a display. A safety-related or urgent alert may take priority over a convenience alert. For example, if a piece of equipment is moving dangerously close to a parked vehicle, an alert notifying the operator of the situation may take priority over displaying engine RPM.

In one example, priority determinations may be based upon a distraction index assigned to an application. The distraction index, for example, may be based upon sophisticated algorithms implemented by the Head-Up Display Controller to regulate content that is displayed based upon factors such as, without limitation, a level of complexity associated with the information the application is displaying/processing, how critical the information is, whether or not the user is requesting the information, whether or not the vehicle operator will need to input additional data, or navigate through menu options, and how complex the symbology is for each item displayed. One having skill in the art will recognize that other factors may also be considered in prioritizing display output.

Displaying multiple sources of information with various levels of priority on HUD Image 4-6 may, in some examples, necessitate overriding of display content with sources of information based upon a similar or higher distraction index. However, if varying levels of distraction indices have been selected by a user, multiple sources of information may be displayed simultaneously. For example, a display speed application may have a lower distraction index than navigation application 810. Therefore, if a vehicle operator has selected navigation application 810, but would also like to know how fast they are moving, the speed application may be selected by the vehicle operator and displayed simultaneously while the navigation application is running. In one example, if it is determined that the vehicle is exceeding the speed limit, a driver alert may appear in the form of a message in alert message area 806. The message may tell the vehicle operator that they are exceeding the speed limit. In one example, all other information in main display area 802 may be suppressed such that only the speed alert message is displayed.

By way of another example, if a vehicle operator has selected and is running navigation application 810, selection of another application with a corresponding high distraction index, for example, music application 812, that requires scrolling through a song list, may result in the suppression of certain information associated with the navigation application to display other information from the newly selected music application. Upon selection of a song within the music application, the information associated with the navigation application may again be displayed to the vehicle operator.

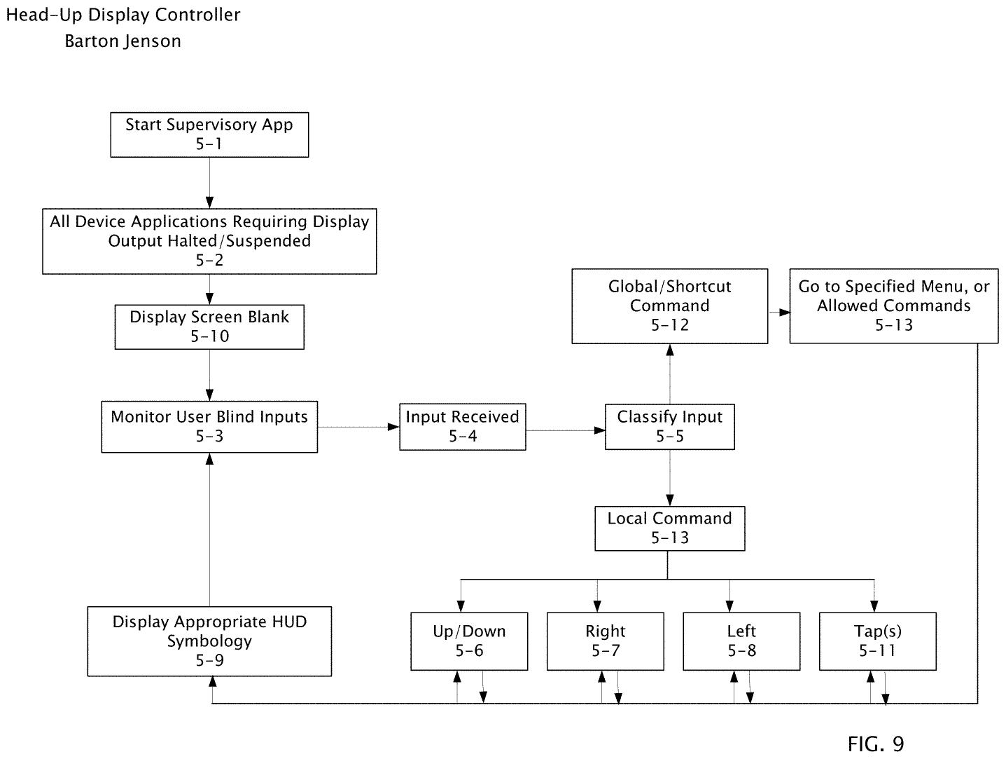

FIG. 9 illustrates a flow chart for Head-Up Display Controller, according to one embodiment. The Head-Up Display Controller may manage the control of all devices and subsequent display of information on the HUD. Once the application is started (5-1), all device applications that require display or other output may be halted or suspended (5-2). This may be done in order to carefully direct only critical display content to the HUD, which may be positioned to keep the vehicle or equipment operator's eyes on the road or job. In order to encourage the operator to keep their eyes on the road or job, the application may render the mobile device's screen blank (5-10). The blind user input (5-3) may be enabled and may continuously monitor user inputs. Once an input is received (5-4), it may be classified (5-5) according to whether it is a global (5-12) or local (5-13) command.

Global commands may allow the user to navigate quickly, via shortcuts, to specific applications, menu options, or functions within the systems suite of applications. Local commands may allow the user to navigate amongst menu options and application functions locally, or at the current state of the system's operation. Four example simple user local inputs are shown; the up/down stroke (5-6), which may increment the menu option to the next or prior item in the list, the right stroke (5-7), which may cause the software to enter a sub-menu for a currently selected menu item, the left stroke (5-8), which may cause the software to exit the current sub-menu item and go to a parent menu list, and combination of taps (5-11), which may select an item from a menu list, or execute a command or function for the currently selected item if allowed. The global/Shortcut Command (5-12) may be a special symbol that may take the system directly to a desired application, menu or allowed commands (5-1 3). After a blind user input is processed, including the navigation of software to the appropriate menu selection of command, appropriate HUD display symbology (5-9) may be made viewable to the user.

The blind user inputs may be generalized to any input that does not require the vehicle or equipment operator to significantly divert their visual attention or cognitive attention from an important task. This may include inputs from a touchpad on laptop computer, or voice input to a microphone, or video input through a camera or vision system, or a thumbwheel or a tactile push-button device (both of which could be directly mounted to a steering wheel, for example, and connected to the HUD Controller via, for example, a BlueTooth wireless connection.). A separate, dedicated blind input device may be used in combination with a smart-phone, or laptop, or tablet computer, or any device with a computer processor, whereby software may not be located on the dedicated blind input device, but rather on the device with the computer processor. It may not be necessary to view either that input device or the device with the computer processor and HUD system application software.

Outputs from the system may also be generalized to include audio output, or touch output such as vibrating transducers, to augment the HUD image output and further encourage the operator to keep their eyes on the road or job in the event the job requires them to look briefly away from the HUD display output.

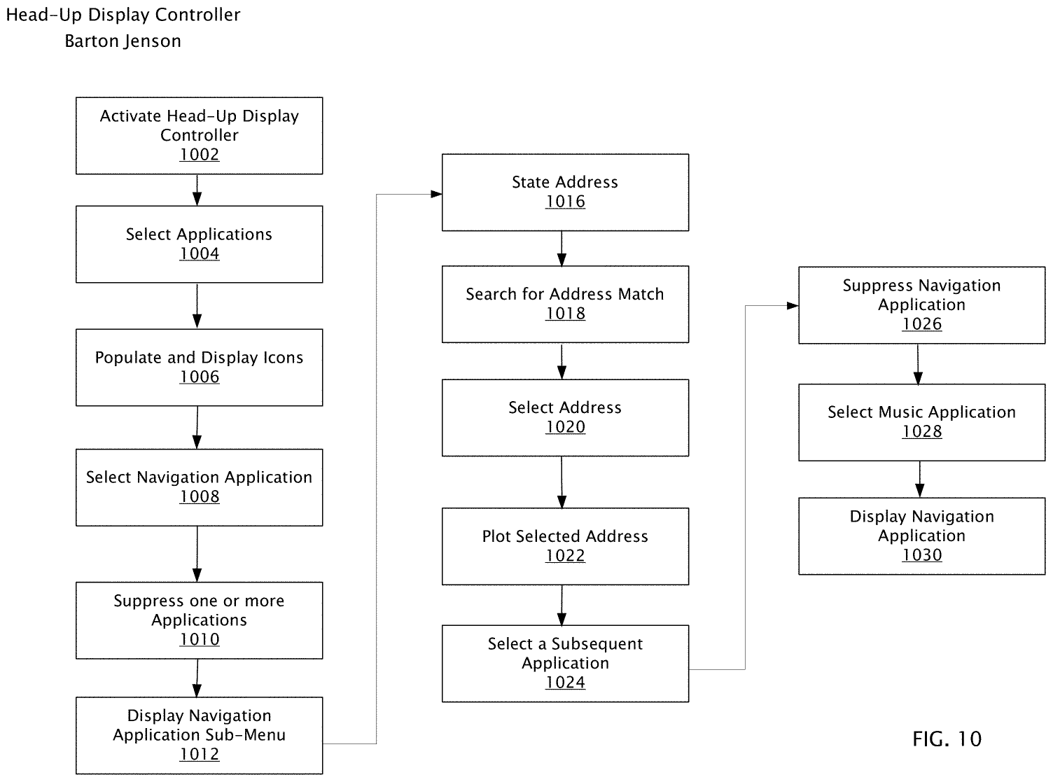

FIG. 10 illustrates a flow chart for selection of various sources of information and display on HUD, according to one embodiment. At 1002, a user may activate a Head-Up Display Controller. For example, a user may activate the Head-up Display Controller through a selection of a head-up application from a device. Selection of the head-up application may render a screen of the device blank, e.g., a black screen. In another example, selection of a head-up application may generate a message on the device screen indicating that the device is now in “HUD Mode.” At 1004, the user may select three applications to be displayed on a main display area similar to that illustrated in FIG. 8 at 804. For example, a user may a blind input gesture, such as a right swipe motion similar to that described with reference to Table 1, on the HUD Controller Interface. The blind input gesture may result in the display of a menu including application icons. A user may, for example, scroll through the menu of icons using a blind input gestures on the HUD Controller Interface, such as an upward or a downward motion, similar to that referenced in Table 1. As the user scrolls through the icons, no more than three icons will be displayed to a user at one time. In one example, the three applications may include a phone application, a navigation application, and a music application. However, it is to be appreciated that the user may access other applications included in the menu of application icons, such as, without limitation, a speed application, a gauge's application, or the like. At 1006, an icon representing each of the three selected applications may be populated and displayed in the HUD Image 4-6, for example, in control main area 804. In one example, the application icon that is displayed in the center of the three selected icons, for example, music application 812 of FIG. 8, would be the application that is launched by the Head-up Display Controller. The center application icon may be highlighted or outlined in some manner, such as a box, signifying the selection to the user. At 1008, a user may launch the navigation application icon utilizing a simple swipe or gesture to the right (as outlined in Table 1). At 1010, upon the launch of the navigation application, the icons representing the music application and the phone application may be suppressed. In one example, suppression of the music application and that phone application may be a result of the distraction index associated with each of the applications. At 1012, a display of three sub-menu options corresponding to the selected navigation application may be presented to the user, for example, on main display area 802. In one example, the three sub-menu options may include: (1) Would you like to look up a new address, (2) Do you want to view recent addresses, or (3) Voice (which if selected may activate a microphone enabling the vehicle operator to utilize voice commands/instructions). However, it is to be appreciated that any number of sub-menu options may be displayed. Continuing with the example, at 1014, the user may select sub-menu (3) Voice, by using a simple swipe gesture to the right. At 1016, the vehicle operator may state an address. In one example, the vehicle operator may have simply stated “home.” At 1018, a search for the most likely match to what the vehicle operator voiced is displayed. For example, if the user stated “home,” the search may result in two addresses closely resembling this request, a primary home, and a vacation home. The two addresses affiliated with each location may be displayed to the vehicle operator. At step 1020, the user may perform a simple swipe up or down, selecting the desired address. At step 1022, the navigation application may begin to plot a course to the destination.

Continuing with this example, while the navigation application is running, the vehicle operator may wish to access the music application 812. At 1024, the user may select, using a simple swipe right gesture, the music application. However, because music application 812 has a high distraction index, at 1026, the navigation application is suppressed, and a display of one or more playlists, songs, albums, etc., are now displayed. Navigation Application may still be running in the background, but the vehicle operator would not have the ability to view it because it may complicate the display format and tax the vehicle operator such that the distraction may take away from the primary focus of operating the vehicle. At 1028, the user makes a music selection using the simple gestures described in Table 1. At 1030, the navigation application again is displayed on main display area 802, and the user continues to the previously selected destination.

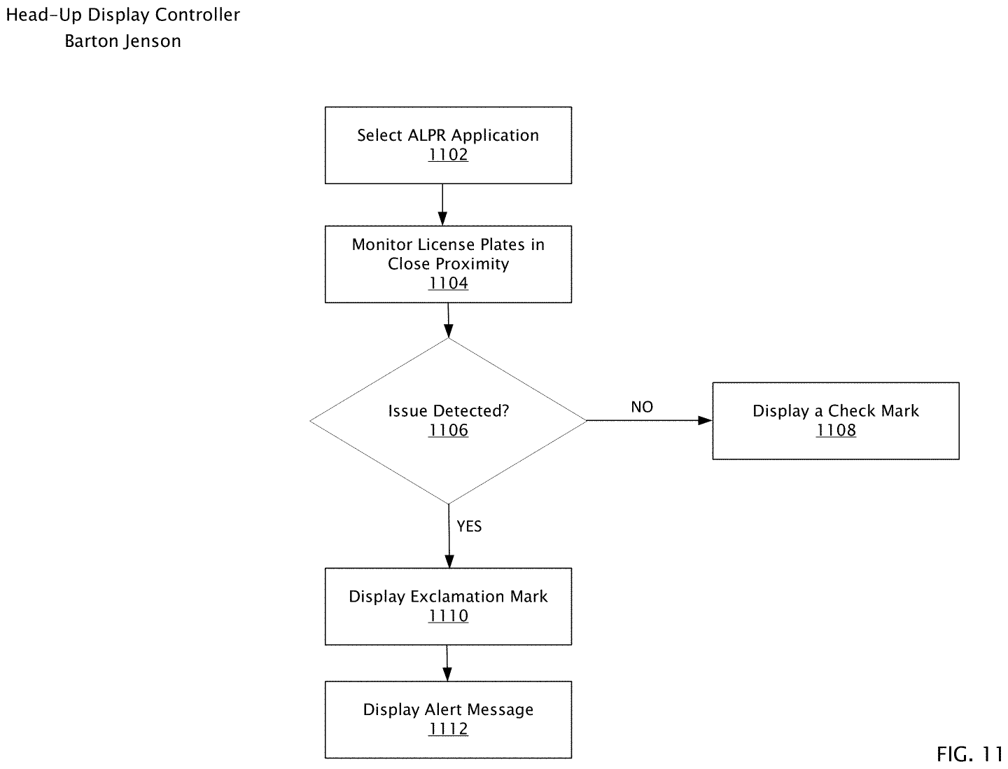

FIG. 11 illustrates a flow chart for selection of various sources of information and display on HUD for a first responder, according to one embodiment. For example, a first responder (i.e., police officer, fire department, etc.) may choose to display application(s) to assist them with their duties. Applications utilized by first responders may include, without limitation, an automatic license plate reader (ALPR), a navigation application, a radar application, communication with other first responders and/or a dispatch center, and the like. Display of information and/or alerts associated with one or more of these applications permits, for example, a police officer to monitor license plate information and/or speed associated with nearby vehicles, without having to take their eyes off of the road. For example, at 1102, a police officer may select the ALPR application. That application may be running in the forefront of the system, or it may be running in the background. In either scenario, at 1104, the ALPR application monitors license plates affixed to vehicles that are in a relatively close proximity to the first responder. At 1106, the ALPR determines whether there is an issue detected with any captured license plate. At 1108, if the ALPR application does not detect any issues associated with a license plate captured by a camera associated with the application, a simple checkmark is displayed in either a main display area similar to that of main display area 802, or the alert symbol area 804, enabling a first responder to quickly receive the alert based information in a simple icon format without taxing him or her with having to read details associated with the license captured unless necessary. However, if at 1110, the ALPR application detects an issue (i.e., expired tabs, warrant for arrest, stolen vehicle, etc.) associated with a captured license plate, an exclamation mark (or other indication) may be displayed in the main area display 802 or the alert symbol area 804. In addition, at 1112, a message may be displayed, for example, in alert message area 806, providing the police officer with additional information associated with the captured license plate. If the ALPR application is running in the background of the system, the application may override any other application that may be running, for example, navigation application, or radar application, so the police officer will be on full alert of the information detected by the ALPR application.

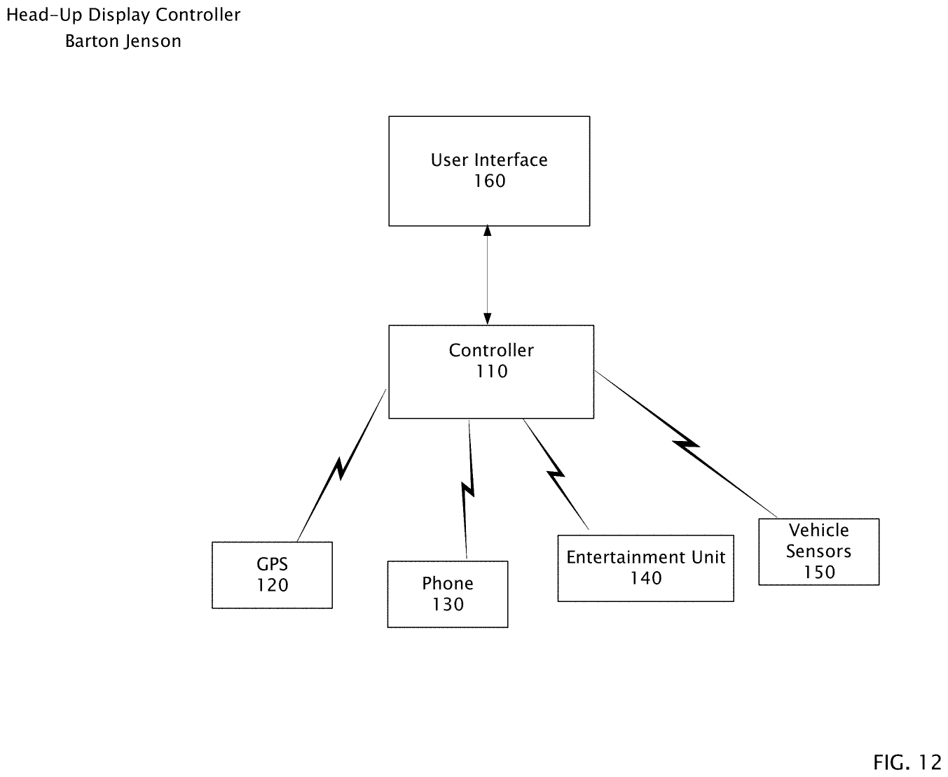

FIG. 12 is a system diagram of one embodiment of a Head-Up Display Controller. The system may comprise Controller 110, which may execute Head-Up Display Controller, and various attached devices, such as GPS Unit 120, Phone 130, Entertainment Unit 140, and Vehicle Sensors 150. Controller 110 may be a smartphone, a laptop or tablet computer, or may be a device designed and configured to execute Head-Up Display Controller.

Controller 110 may be coupled to each attached device by wire, a wired bus, Wi-Fi, cellular data access methods, such as3G or 4GLTE, Near Field Communications (NFC), Bluetooth, the internet, local area networks, wide area networks, or any combination of these or other means of providing data transfer capabilities. Other devices may also be attached to Controller 110.

User Interface 160 may include a Head-Up Display and may include other means of communicating with a user, such as audio output or tactile output, including vibration. One having skill in the art will recognize that other forms of user interface may be used in various applications.

User Interface 160 may also include one or more means of receiving inputs. For example, User Interface 160 may include a touch screen, speech recognition, a keyboard, a mouse, a joystick, or other means for accepting inputs from a user. One having skill in the art will recognize that various forms of input may be acceptable for controlling attached devices.

Controller 110 may, for example, communicate with Phone 130 via Bluetooth, and may allow a user to place or receive phone calls, and may, for example, display a caller ID phone number on a Head-Up display upon receiving a call, allowing the user to answer or ignore the call with a touch or a gesture on a blind input interface, such as the touchscreen described herein, on the Head-Up display. A phone book may be displayed and may allow a user to select a number to call by a touch screen interface on a Head-Up display. Controller 110 may then send appropriate commands to Phone 130 to initiate a call.

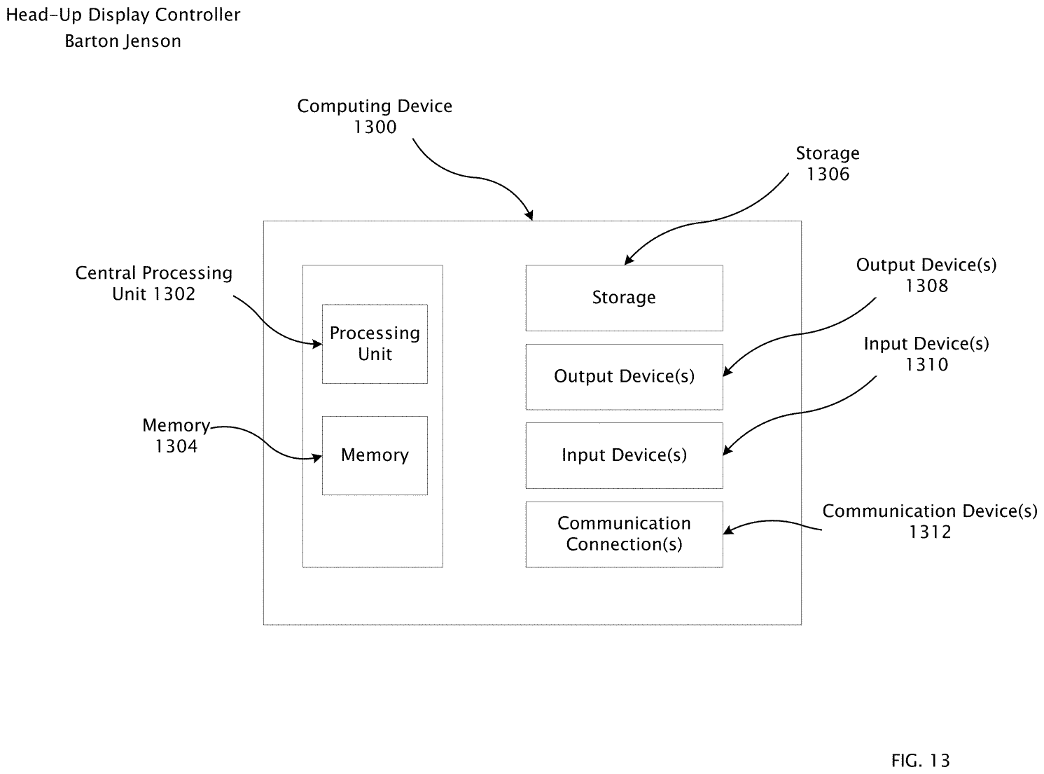

FIG. 13 illustrates a component diagram of a computing device according to one embodiment. The Computing Device (1300) can be utilized to implement one or more computing devices, computer processes, or software modules described herein, including, for example, but not limited to Controller 110. In one example, the Computing Device (1300) can be utilized to process calculations, execute instructions, receive and transmit digital signals. In another example, the Computing Device (1300) can be utilized to process calculations, execute instructions, receive and transmit digital signals, receive and transmit search queries, and hypertext, compile computer code as required by Controller 110. The Computing Device (1300) can be any general or special purpose computer now known or to become known capable of performing the steps and/or performing the functions described herein, either in software, hardware, firmware, or a combination thereof.

In its most basic configuration, Computing Device (1300) typically includes at least one Central Processing Unit (CPU) (1302) and Memory (1304). Depending on the exact configuration and type of Computing Device (1300), Memory (1304) may be volatile (such as RAM), non-volatile (such as ROM, flash memory, etc.) or some combination of the two. Additionally, Computing Device (1300) may also have additional features/functionality. For example, Computing Device (1300) may include multiple CPUs. The described methods may be executed in any manner by any processing unit in computing device (1300). For example, the described process may be executed by both multiple CPU's in parallel.

Computing Device (1300) may also include additional storage (removable and/or non-removable) including, but not limited to, magnetic or optical disks or tape. Such additional storage is illustrated in FIG. 5 by Storage (1306). Computer-readable storage media includes volatile and nonvolatile, removable and non-removable media implemented in any method or technology for storage of information such as computer-readable instructions, data structures, program modules or other data. Memory (1304) and Storage (1306) are all examples of computer storage media. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, SIM or other solid-state memory device, or any other medium which can store the desired information, and which can be accessed by computing device (1300). Any such computer-readable storage media may be part of computing device (1300). Computer-readable storage media does not include transient signals.

Computing Device (1300) may also contain Communications Device(s) (1312) that allow the device to communicate with other devices. Communications Device(s) (1312) is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer storage media and communication media. The described methods may be encoded in any computer-readable media in any form, such as data, computer-executable instructions, and the like.

Computing Device (1300) may also have Input Device(s) (1310) such as keyboard, mouse, pen, voice input device, touch input device, etc. Output Device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A vehicular interface system, comprising:
a head-up display adapted to present visual information in a line-of-sight of an operator of vehicle;
an input device adapted to receive input from an operator, wherein the input device is a blank input device operable to use a blind input gesture, and wherein the input corresponds to an application selection from one or more applications presented to the operator;
software running on a controller, the software operable to prioritize the one or more applications according to a corresponding distraction index; and
a device coupled to the controller operable to regulate display of the one or more applications based upon the corresponding distraction index.

2. The system of claim 1, wherein the distraction index is based upon at least one of a level of complexity associated with information the application is displaying, how critical the information is, whether or not the operator is requesting the information, whether or not the vehicle operator will need to input additional data, navigate through menu options, or how complex the symbology or a symbology set is for each application displayed.

3. The system of claim 1, wherein the one or more applications comprise at least one of a music application, a navigation application, a speed application, or a phone application.

4. The system of claim 1, wherein the device coupled to the controller operable to regulate display of information associated with the one or more applications based upon the corresponding distraction index further comprises suppressing information corresponding to an application to display information corresponding to another application.

5. A method, comprising:
sending a request for information to a device;
receiving the requested information from the device;
determining relevant high priority information from the received information; and
displaying the high priority information on a head-up display.

6. The method of claim 5, wherein the determining relevant high priority information comprises selecting at most three items of information.

7. The method of claim 5 wherein the device is selected from a group consisting of a smartphone, a GPS, a vehicle sensor, an entertainment unit, a laptop, and a tablet.

8. The method of claim 5, wherein the determining relevant high priority information comprises determining if the information relates to a safety issue.
